(19) United States
(12) Patent Application Publication
(10) Pub. No.: US 2018/0361807 A1
(43) Pub. Date: Dec. 20, 2018

(54) Flat Compression Pump

(71) Applicant: Benjamin J. Krempel, Saint Charles, IL (US)

(72) Inventor: Benjamin J. Krempel, Saint Charles, IL (US)

(21) Appl. No.: 16/061,297

(22) PCT Filed: Dec. 28, 2016
(86) PCT No.: PCT/US2016/068964

§ 371 Date: Jun. 11, 2018

Related U.S. Application Data
(60) Provisional application No. 62/272,964, filed on Dec. 30, 2015.

(51) Int. Cl. B60C 23/12; B60C 17/01

(52) U.S. Cl. CPC B60C 23/12; B60C 2200/12; B60C 17/01

(57) ABSTRACT

A self-inflating pumping mechanism for tires or tubes is provided. Two arc-shaped lever arms connected through a hinge enclose a lumen/collapsible cavity below the hinge. The design provides great mechanical leverage, which is generated by the lever arms and exerted directly onto the lumen. This translates into higher pumping pressures, lower activation loads, better ride quality and lower energy consumption. The design has a lumen that is mechanically isolated from the inner tube or air pressure in the main cavity of the inner tube, avoiding the need to reinforce the lumen against the pressure of the tire. The lever arms and hinge carry the load directly above the lumen and transfer the load directly to the tire

### FIELD OF THE INVENTION

The invention relates to self-inflating pumping mechanisms for tires or tubes.

### BACKGROUND OF THE INVENTION

Self-inflating pumping mechanisms have become popular as they self-inflate the tire or tube using the energy of the wheel while driving or riding to maintain a desired pressure level. Even though this technology has made great strides, current designs have disadvantages. A piston cylinder design for example causes bumpy rides, unbalanced tire, adds weight due to multiple systems required to balance the tire, are complex, and the deformation of the tire becomes less as the tire inflation increases resulting is less self-inflating pumping action. A rim hub mounted design also adds weight, requires the purchase of a new rim, and the rim is not a component that is usually purchased when repairing a flat tire.

### SUMMARY OF THE INVENTION

The present invention provides a self-inflating pumping mechanism for tires or tubes. The self-inflating pumping mechanism distinguishes two arc-shaped lever arms connected through a hinge. The two lever arms conform at least partially to the inside profile and circumference of an unloaded tire or tube.

The two lever arms are capable of flexing around the hinge when a tire or tube is under load and are thereby deformed. In one variation the hinge is a living hinge. In another variation, the material of the hinge and the two arc-shaped lever arms are the same. In still another variation, the material of the hinge is a gradient compared to the material of the two arc-shaped lever arms. In still another variation, the inner tube serves as the hinge for the lever arms. The self-inflating pumping mechanism can expand and contract in length. The self-inflating pumping mechanism can further include an anti-friction layer on the inner surface of the tire or tube or on the surface of the two lever arms.

A collapsible lumen is located below the hinge and located between the inner ends of the two lever arms. The collapsible cavity is capable of being compressed while the two lever arms flex when the tire or tube deforms under load; the compression of the collapsible cavity enables the pumping mechanism. In one variation, the two lever arms enclose the collapsible cavity. In another variation, the lever arms and compression surface have a 3:1 ratio in length. In yet another variation, the lumen cavity is protected from sharp object puncture by the lever arms. In still another variation, compression is provided from forces acting along the length of the Z-axis. In still another variation, the anti-friction layer is incorporated into the lever arm design. In still another variation, the lumen and the tube are one piece.

A check valve ensures that air flows from the atmosphere through the pumping mechanism of the collapsible cavity and into the main chamber of the tire or tube. In one variation, two or more check valves can be used in series. In another variation, the pumping mechanism has check valves at intervals along the length of the pumping mechanism. In still another variation, more than two check valves are employed along the length of the lumen.

In yet another variation, the check valves are dynamically formed. Dynamically-formed check valves refer to the FIGS. 9, 10, 11 and 14, 15, 16. The dynamic check valves are not stand alone check valves, but rather design elements that close and seal the lumen while it is being compressed. This allows the pumping mechanism to operate with a lower force because the lumen is not required to be compressed continuously along its length with enough force to seal the lumen and push the air forward. Rather, the dynamic check valves form a sealing area and chamber while the tire is rolling. The sealing area, i.e., dynamic check valve, closes the lumen thereby blocking air from flowing backwards while the chamber is mostly emptied of air. Then as the tire rolls, a new dynamic check valve is formed in front of the contact patch and the old previous dynamic check valve returns to the open state. This design allows the use of multiple check valves in the pumping mechanism without impeding the vacuum needed to draw in new air into the system.

There are many advantages to the embodiments of this invention compared to other designs. One of the key advantages is achieved by placing the lumen between the lever arms and below the hinge. The placement of the lumen results in two profound design advantages. First, great mechanical leverage is generated by the lever arms and exerted directly onto the lumen. This advantage can be translated into higher pumping pressures, lower activation loads, better ride quality and lower energy consumption. The second advantage is that the lumen is mechanically isolated from the inner tube or air pressure in the main cavity of the inner tube. This means bulky materials do not need to be added to reinforce the lumen against the pressure of the tire. The lever arms and hinge carry the load directly above the lumen and transfer the load directly to the tire.

In addition to these two main advantages there are also several other noteworthy advantages. The ride quality is not diminished compared to a traditional inner tube. The force used to flex the lever arms is spread across the surface of the levers and so it does not create a noticeable high spot or ridge in the tire, which could cause the tire to feel unstable. The invention leaves the sidewalls of the tire unobstructed which means shock absorption of sidewalls is not dampened.

Through the use of dynamic check valves, the system does not require the lumen to be completely compressed across its entire length to pump air. This is important because it lowers the overall force required to collapse the lumen for a given pumping performance. This can result in higher pumping pressures or lower minimum activation loads for the pumping mechanism.

### BRIEF DESCRIPTION OF THE DRAWINGS

FIGS. 1-2 show an X-Y plane view according to an exemplary embodiment of the invention of a self-inflating pumping mechanism with two arc-shaped lever arms 1, a hinge 2, and a collapsible cavity or lumen 3.

FIGS. 3-4 show a Z-axis view of two arc-shaped lever arm of the self-inflating pumping mechanism according to an exemplary embodiment of the invention. FIG. 3 shows a neutral state, and FIG. 4 shows a deformed state.

FIGS. 5-6 shows an X-Y plane view of respectively FIG. 3 and FIG. 4 according to an exemplary embodiment of the invention.

FIGS. 7-8 shows an X-Y plane view of respectively FIG. 3 and FIG. 4 according to an exemplary embodiment of the invention. In FIGS. 7-8 the self-inflating pumping mechanism is shown inside a tire or tube.

FIG. 9 shows a Z-axis view of the lever arms and a lumen with multiple dynamic check valves along its length according to an exemplary embodiment of the invention.

FIG. 10 shows a Z-axis view of the lever arms and lumen, where features on the upper lever arm create dynamic check valves in series according to an exemplary embodiment of the invention.

FIG. 11 shows a Z-axis view of the lever arms and lumen where features on both the upper and lower lever arms work in tandem to create dynamic check valves in series according to an exemplary embodiment of the invention.

FIG. 12 shows shows a Z-axis view of the lever arms where stress reliefs are designed into the lever arms according to an exemplary embodiment of the invention. The stress relief features may be placed with varying frequency, shape, orientation and design.

FIG. 13 shows a Z-axis view of the lever arms where the stress relieve features allow the pumping mechanism to expand and contract in length according to an exemplary embodiment of the invention.

FIG. 14 shows a dynamic check valve which is formed by incorporating a band of thicker material around the lumen. The band can be a separate piece or can be a featured directly manufactured as part of the lumen according to an exemplary embodiment of the invention.

FIG. 15 shows a dynamic check valve which is formed by incorporating a ring of thicker material around the lumen. The ring can be a separate piece or can be a feature directly manufactured as part of the lumen according to an exemplary embodiment of the invention.

FIG. 16 shows a dynamic check valve which is formed by incorporating a band of material inside the lumen. The band can be a separate piece or can be a featured directly manufactured as part of the lumen according to an exemplary embodiment of the invention.

FIGS. 17-20 show a self-inflating pumping mechanism according to exemplary embodiments of the invention where the two arc-shaped lever arm and the hinge are an integral design with similar material or a gradient material. FIGS. 18 and 20 also show the collapsible cavity or lumen being enclosed. FIG. 18 shows a protective layer underneath the pumping mechanism which provides puncture protection and a surface for reducing friction between the pumping mechanism and its riding surface.

FIGS. 21-22 show a self-inflating pumping mechanism according to exemplary embodiments of the invention where elements of the pumping mechanism are integrated into the inner tube. The figures also show the edges of the pumping mechanism tapering in thickness to blend with the inner tube at the edges. FIG. 21 shows the hinge incorporated into the inner tube. FIG. 22 shows both the lumen and the hinge incorporated into the inner tube.

FIGS. 23-24 show cut out views of the self-inflating pumping mechanism integrated within a wheel system according to an exemplary embodiment of the invention.

### DETAILED DESCRIPTION

Embodiments of the invention include a design for a self-inflating pumping mechanism. The design has two arc-shaped lever arms that encircle, at least partially, the major circumference of the tire. In its most basic design, the elements of the design include:
Two lever arms
A hinge
A lumen which is located below the hinge
A check valve
A coupling means between the pumping mechanism and the valve stem

The design may also include:
More than one check valve
An anti-friction means on the inner surface of the tire

How it Works

The design takes advantage of the shape change of the tire to actuate the pumping mechanism. As the load on the tire pushes against the pavement, the tire flattens. This change in shape causes the pumping mechanism to flatten and thereby squeeze the air forward through the lumen. The design directly compresses the lumen much like a pair of pliers and therefore is very efficient.

It is easy to calculate the force multiplication by calculating or measuring the length of the lever arms. The air may be pushed into the inner tube in two manners. In the first manner, the air is pushed around the tire in a peristaltic motion and then into the inner tube. This manner of operation is applicable for longer cavity lengths, e.g., longer than 100 mm, where high pumping volumes are required. Mountain and city bikes are applications where cyclists may typically travel less than 20 km per month and would benefit from a high air pumping capacity.

In the second manner, the air may be pushed into the inner tube with a single squeezing action. This is applicable for shorter cavity lengths, e.g., less than 100 mm, where lower pumping volumes are sufficient. Electric bikes are an application where lower pumping volumes are desirable because typical monthly riding distances are high and can be estimated at greater than 20 km per month. This second manner would also benefit from lever arms that completely encircle the tire. This provides uniform tire balance, puncture protection and uniform ride quality.

Interval Check Valves

The design uses one or more check valves to ensure that air flows from the atmosphere through the pumping mechanism and into the main chamber of the tire. The design may also use check valves placed at intervals along the length of the lumen. This can be accomplished through the use of traditional ball check valves such as those provided by The Lee Company located in Westbrook, Conn., U.S. The check valves can also be any other type of check valve available in industry including thin-film check valves and elastomeric check valves. The use of check valves reduces or eliminates the need for the lumen to seal continuously along its length.

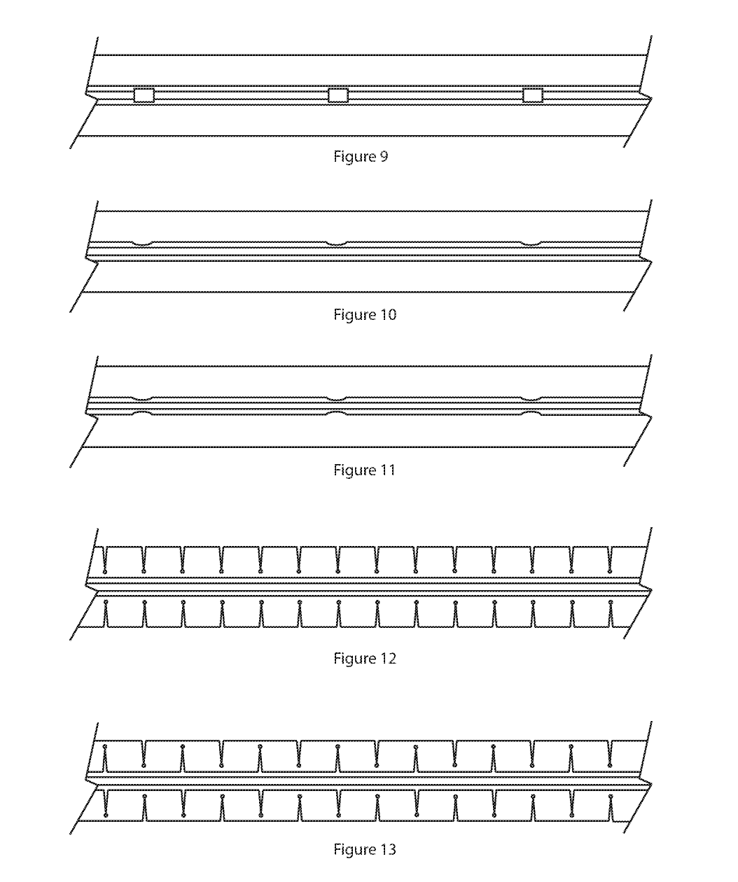

The design may also use an entirely new type of dynamic check valve that is built into the design of the pumping mechanism. The dynamic check valves can be designed in such that they are open when not deformed and thereby have zero cracking pressure. Once deformed by the activation of the pumping mechanism, the check valves seal at intervals and thereby reduce the overall force required to activate the pumping mechanism. This feature would be beneficial for applications where high pressures are need to be generated or where the load on the tire is very small such as children's applications. FIG. 14 shows an elastomeric design where a sleeve is placed over the lumen creating an area that requires less displacement of the lever arms to close. FIG. 9 shows the design placed between the lever arms of a pumping mechanism. A similar design in FIG. 15 shows an O-ring instead of the sleeve. In both designs, the dynamic check valve can be separate pieces from the lumen or co-manufactured as one part. FIG. 16 shows the cross-section of a third design where the dynamic check valve is located inside the lumen.

The dynamic check valve functionality could also be located on the lever arms as shown in FIG. 10 and FIG. 11 where features on one or both lever arms narrow the gap for the lumen and thereby seal the area. One of the benefits of engineering the dynamic check valve into the lever arms is that it does not increase the part count.

The interval between the check valves can differ along the length of pumping mechanism to make the pump more efficient for pumping higher pressures at the end of the pumping mechanism than for example at the beginning of the pumping mechanism where the system is drawing in air at atmospheric pressure. A typical interval between check valves for a 700 mm diameter tire could be between 50-100 mm. Ideally each dynamic pumping chamber would be just slightly shorter than the contact patch of the tire against the pavement. This would allow the dynamic chamber to form and push most of the air from the chamber forward through the lumen before the dynamic check valve opens up as it passes beyond the contact patch. Each dynamic check valve increases the resistance to flow though the lumen so it is desirable to optimize the number of dynamic check valves.

Force Along the Z-Axis

The pumping mechanism takes advantage of the deformation of the tire in the X-Y plane and along the Z-axis. The design separates and optimizes these two effects. The deformation in the X-Y plane is described above where the cross-section of the tire flattens and this causes the lever arms to flatten.

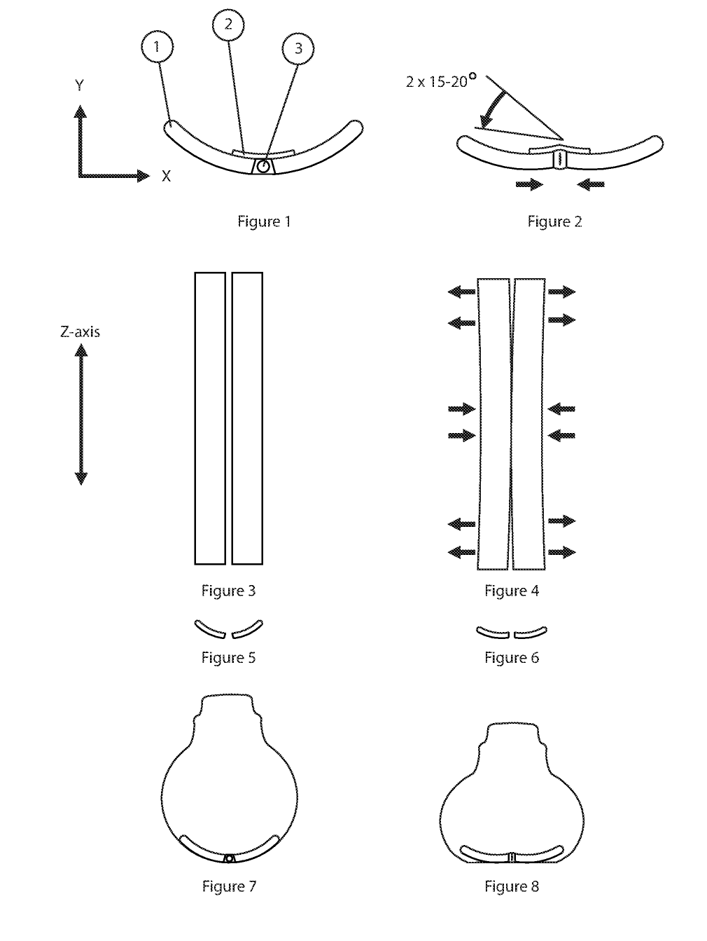

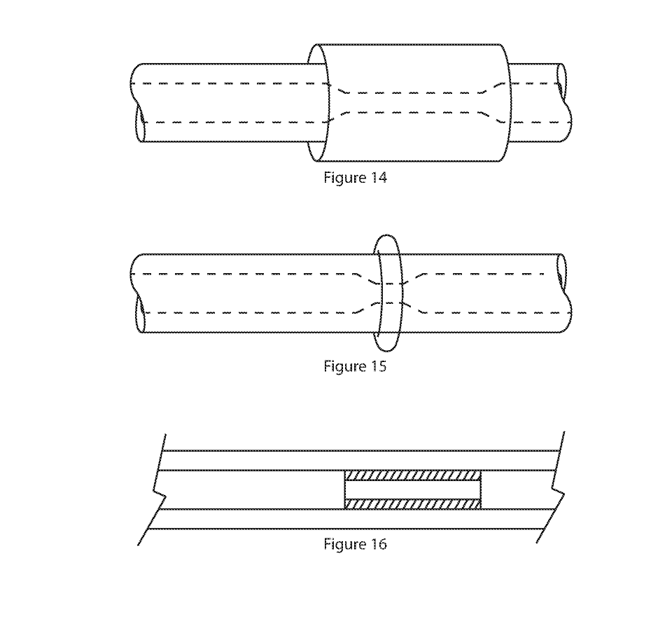

The flattening of the tire along the Z-axis works in similar but different fashion. When the tire is not under load and not deformed, the two lever arms are parallel to each other and connected by a hinge, as shown in FIGS. 1, 3 and 7. When the tire is loaded and the lever arms deform turning inward, their orientation to each other is no longer parallel, but rather two oppositely opposed arcs. The stresses on the deformed lever arms can be seen in FIG. 4. In the invention both lever arms are held together by the hinge which means the distance between the lever arms in FIG. 4 would not be present as shown in the figure, but the stresses would be present. These compression forces can be used to further optimize the pumping of air. Cutting slits into the lever arms such as in FIG. 12 and FIG. 13, diminishes the forces generated along the Z-axis. The design of the pumping mechanism can be optimized to increase or decrease the effect of the tire deformation along the Z-axis.

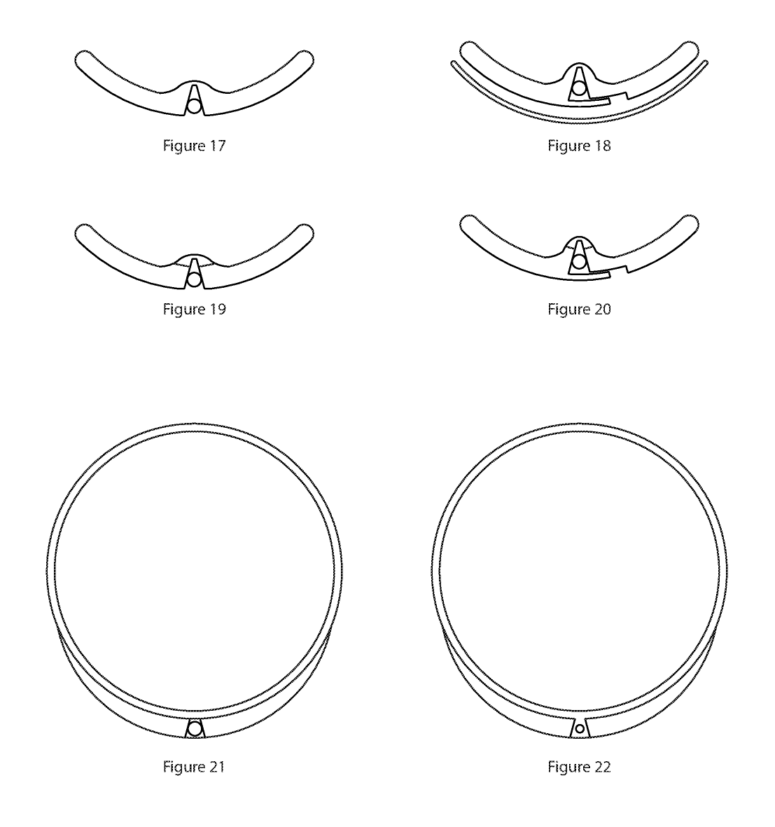

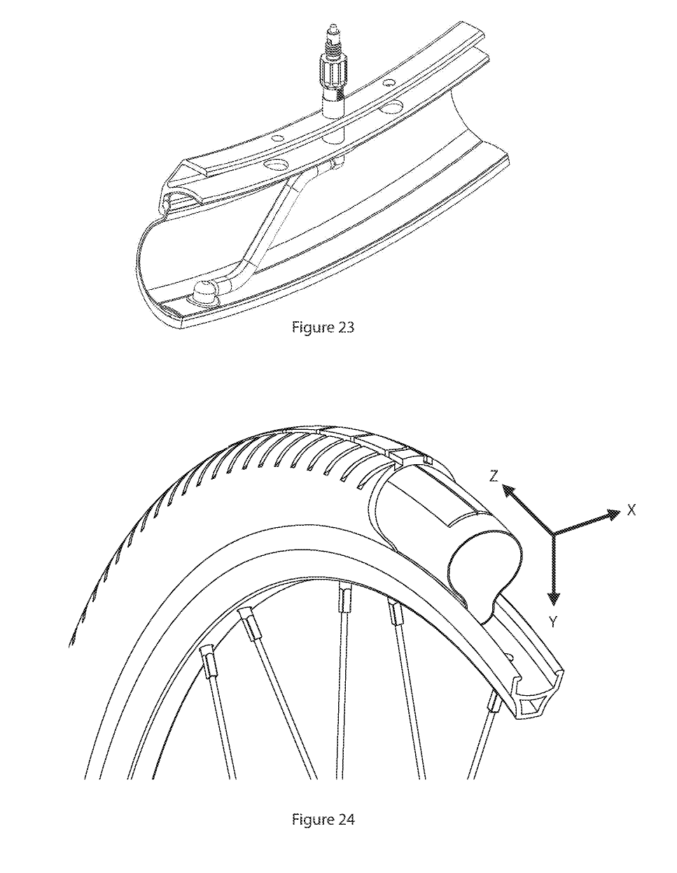

The hinge material is resistant to stretching. The hinge may be made of the same material as the lever arms or it may be made of different materials. FIGS. 17 and 18 show an integrated living hinge made of the same materials as the lever arms. When under load, the tire deforms and the levers turn outward as seen in FIG. 2. When the tire flattens, the outside edges of the lever arms rotate downward as they flatten against the contact patch. Each side rotates about 15-20 degrees or 30-40 degrees between the two of them. The angle change and flattening of the pumping mechanism change the geometry between the two levers and they are no longer parallel. FIG. 4 shows what the flattened levers would look like when placed next to each other and not bound by the hinge. It is clear to see there is considerable curve along the inside and outside edges of the levers. In the invention, however, the levers are bound by the hinge and the result is considerable compression is generated at the center of the deformed area. Tension is generated in the levers toward the edges of the deformed area as seen in FIG. 4. It is the compression forces in the center of the deformed area that are harnessed to collapse the lumen.

The design may be placed inside the inner tube or outside the inner tube. The design may be used in a tire with an inner tube or without an inner tube. The lever arms are held in position by the air pressure inside the inner tube and the inside surface of the inner tube in the first case. The lever arms are designed to conform to the inside profile of the pressurized, unloaded tire.

In the case where no inner tube is used, the lever arms are held in place by the pressure inside the tire. The bottom surface of the lever arms conforms to the pressurized, un-loaded shape of the inside of the tire.

Lever Arm Design Features

The design of the lever arms in FIG. 13 shows one of the ways in which the pumping mechanism can be designed to fit tires of varying diameters. Even tires made to the same specifications are subject to variation. A 700 c tire has a circumference of approximately 2.2 meters. A 1% variation in the circumference would equal 22 mm. Through the use of designs such as that found in FIG. 13, the length of the pumping mechanism can expand and contract without affecting its performance. This could also be accomplished with anisotropic materials or with a combination of materials to produce a similar effect.

The lever arms could also be designed to directly protect the lumen from puncture and other harm by having a sliding element that extends under the lumen such as in FIG. 18. Another feature in FIG. 18 is the inclusion of an anti-friction surface underneath the lever arms. An Example of this is also found in FIG. 18. The anti-friction surface could also have additional benefit as an anti-puncture surface.

The reinforcement element can used to prevent flats. Reinforcement/anti-puncture elements include nylon, Kevlar, nylon 66, plastics, rubbers, woven materials, non-woven materials and any other material that would provide a barrier to puncturing elements.

In one embodiment the stiffness in the X-Y plane is decoupled from the stiffness along the Z-axis; this can be done by varying the material properties, the material thickness, the geometry, density and other variables.

Materials

The lever arms may be made of rigid or semi-rigid materials. However, the mechanical efficiency of the design is enhanced by the lever-arms having increased rigidity. Suitable materials include rubbers and plastics including ABS, Nylon, Delrin, PEEK, Natural rubber, NBR, TPE, fiberglass, Kevlar, aramid, carbon fiber, DuPont Hytrel and other materials. Materials with high Young's Modulus are beneficial to the design because they flex during the pumping and then give most of the energy back to the system.

The lumen may be made of butyl rubber, natural rubber, silicone rubber, TPE or any other type of elastomeric material. An important consideration for the cavity material is its ability to return energy to the system and not absorb it and turn it into heat. Because the cavity is bounded by the lever arms, the flexible member and the bottom of the tire, the cavity materials do not need to resist much pressure and can be constructed of thin materials. The lumen can also be constructed of materials that stretch easily such as silicon rubbers because the bounding structures will limit the expansion.

What is claimed is:

1. A self-inflating pumping mechanism for tires or tubes, comprising:
(a) two arc-shaped lever arms connected through a hinge;
(b) a collapsible lumen located below the hinge and located in between the inner ends of the two lever arms; and
wherein the two lever arms conform at least partially to the inside profile and circumference of an unloaded tire or tube,
wherein the two lever arms are capable of flexing around the hinge when a tire or tube is under load and thereby deformed,
wherein the collapsible cavity is capable of being compressed while the two lever arms flex when the tire or tube deforms under load, and wherein the compression of the collapsible cavity enables a pumping mechanism; and
(c) a check valve to ensure that air flows from the atmosphere through the pumping mechanism of the collapsible cavity and into the main chamber of the tire or tube.

2. The self-inflating pumping mechanism as set forth in claim 1, wherein the hinge is a living hinge.

3. The self-inflating pumping mechanism as set forth in claim 1, wherein the material of the hinge and the two arc-shaped lever arms are the same.

4. The self-inflating pumping mechanism as set forth in claim 1, wherein the material of the hinge is a gradient compared to the material of the two arc-shaped lever arms.

5. The self-inflating pumping mechanism as set forth in claim 1, wherein the collapsible cavity is enclosed by the two lever arms.

6. The self-inflating pumping mechanism as set forth in claim 1, further comprising an anti-friction layer on the inner surface of the tire or tube or on the surface of the two lever arms.

7. The self-inflating pumping mechanism as set forth in claim 1, wherein the pumping mechanism can expand and contract in length.

8. The self-inflating pumping mechanism as set forth in claim 1, wherein two or more check valves are used in series.

9. The self-inflating pumping mechanism as set forth in claim 1, wherein the lumen and the tube are one piece.

10. The self-inflating pumping mechanism as set forth in claim 1, wherein the tube serves as the hinge for the lever arms.

11. The self-inflating pumping mechanism as set forth in claim 1, wherein more than two check valves are employed along the length of the lumen.
